(19) United States
(12) Patent Application Publication
(10) Pub. No.: US 2010/0102476 A1
(43) Pub. Date: Apr. 29, 2010

(54) Method for manufacturing raised relief maps

(76) Inventor: Michael H. Higgins, New Market, MD (US)

Correspondence Address: Michael H. Higgins, 6778 Accipiter Drive, New Market, MD, 21774, US

(21) Appl. No.: 12/290,194

(22) Filed: Oct. 29, 2008

(51) Int. Cl. B29C 35/04

(52) U.S. Cl. 264/219

(57) ABSTRACT

A method of making a very high resolution raised relief map (190) includes making a very high resolution mold form (82) by means of a rapid-prototyping process such as a three-dimensional printer (80). A high resolution three-dimensional surface (90) is formed on the mold and a thin formable plastic film (60) having high resolution features pre printed thereon is positioned in precise alignment with corresponding features on the mold form. The thin plastic film is then thermoformed against the high resolution surface of the mold to make the high resolution raised relief map (190).

The present invention relates to raised relief maps and more particularly to a method of making very high resolution raised relief maps.

### BACKGROUND OF THE INVENTION

Raised relief maps of geographic areas model the shape of the surface of the earth, showing approximate variations in elevation over the area of interest along with regular map features such as roads, boundaries, feature names, and other thematic detail. Such raised relief maps have an extensive range of applications, including education such as classroom geography, history, geology, and geopolitical as well as recreation such as hiking, kayaking, mountain climbing, and skiing. Other areas of application include aviation for pilot flight planning, advertising/media, military tactical planning, and government functions. These three dimensional maps are normally made by vacuum forming a flexible plastic printed sheet against a formed surface of a mold which models the terrain shape. The surface of the plastic film is normally printed on before forming to provide map feature detail. Traditional printing methods use silk-screen or off-set press processing. Such prior art relief maps are manufactured by Hubbard Scientific Inc., of Chippewa Falls, Wis. The terrain forming molds have been generally made of metal or plastic using a machine tool to cut the terrain shape, or by hand-forming the terrain out of a molding material. These traditional methods of terrain mold making result in both lower resolution molds and a higher manufacturing cost. Many of the current users of raised relief maps could benefit from raised relief maps with very high terrain accuracy and resolution, combined with very high printed image resolution. Such applications and users could be geographic higher educators teaching high-school and college level geographic or geology courses, outdoor recreation enthusiasts such as hikers, skiers, hang-gliders, and National Park visitors. High-resolution raised relief terrain models can be made by means of a three-dimensional printer or other rapid-prototyping (RP) process that accepts high-resolution terrain/elevation data of a given topographical area. The 3D printer/RP process then forms a very high resolution model of the terrain out of a synthetic material (usually a proprietary polymer). Such 3D printers are made by the Z Corporation, of Burlington, Mass. In fact, the Z Corporation printing process even allows full color printing of the surface of the model, resulting in a functional raised relief map (which can and has been marketed to the public by Landprint, www.landprint.com). The resulting shape of the scaled model of the terrain is of high resolution, but is heavy, small in size and costly to manufacture. The map surface color and image quality is low using this approach. This low quality, small size, and high cost limits the application of a raised relief map made with this method.

Other RP processes include stereo lithography apparatus (SLA), selective laser slintering (SLS) and fused deposition modeling (FDM). Terrain models can and have been made with these processes, and are also of high accuracy/resolution, but are monochromatic (one color). Such single color models can show the terrain surface shape, but not other map features of interest such as roads, borders, natural surface colors, and feature names.

What is needed is method of mass producing relatively thin and lightweight but very high-resolution raised relief maps quickly and at low cost. This invention is novel and unique in that it uses the terrain model produced by the 3D printer or other RP process as a thermal forming tool or pattern for precisely molding high-resolution maps printed on a thin plastic film. The result is a significant increase in the accuracy and resolution of raised relief maps, and a reduction in mold tooling cost.

### SUMMARY OF THE INVENTION

A method of making a very high resolution raised relief map includes the following steps. Means to effect a rapid-prototyping process is provided for making a thermoforming mold having a high resolution three-dimensional surface which models the three-dimensional surface of the earth with very high geographic resolution. A mold is made having the high resolution three-dimensional surface utilizing the rapid-prototyping process. Desired map features are printed on a thin formable plastic film using a conventional printing process. The printed film is then positioned in a thermoforming machine such that it is in close proximity to the three dimensional surface and the desired map features are precisely registered to corresponding features on the high resolution three-dimensional surface. The film is heated to a proper molding temperature, then the space between the film and terrain mold is partially evacuated so that atmospheric pressure forces the film into contact with the high resolution three-dimensional surface, and then cooling the film.

An embodiment of the invention will now be described by way of example with reference to the following drawings.

### DESCRIPTION OF THE DRAWINGS

FIG. 1 is a block diagram of a method of making high resolution relief maps incorporating the teachings of the present invention;

FIG. 2 is a schematic representation of a portion of the method shown in FIG. 1 showing the making of the printed film;

FIG. 3 is a schematic representation of a portion of the method shown in FIG. 1 showing the making of the mold tool;

FIG. 4 is a schematic representation of an alternative embodiment of the portion of the method shown in FIG. 3 showing the making of a mold tool;

FIG. 5 is a schematic representation of a portion of the method shown in FIG. 1 showing a thermoforming machine;

FIG. 6 is a schematic representation similar to that of FIG. 5 showing the beginning of the forming process;

FIG. 7 is a schematic representation of a portion of the method shown in FIG. 1 showing an intermediate stage of the forming process;

FIG. 8 is a schematic representation of a portion of the method shown in FIG. 1 showing the final stage of the forming process; and

FIG. 9 is an isometric view of a high resolution topographical map made by the method shown in FIG. 1.

FIG. 10 is a schematic representation of a small part of the desired raised relief map showing the desired and correct locations of discrete printed elements with respect to the terrain features.

FIG. 11 is a schematic representation of the printed film prior to thermoforming without preprocessing the image to account for terrain shape.

FIG. 12 is a schematic representation of the printed film as it is thermoformed against the mold, and the resulting distortion of the printed map features due to the molding process.

FIG. 13 is a schematic representation of the printed film showing the effect of preprocessing the printed elements so that the molded map element are correctly registered to the terrain shape.

### DESCRIPTION OF AN EMBODIMENT OF THE INVENTION

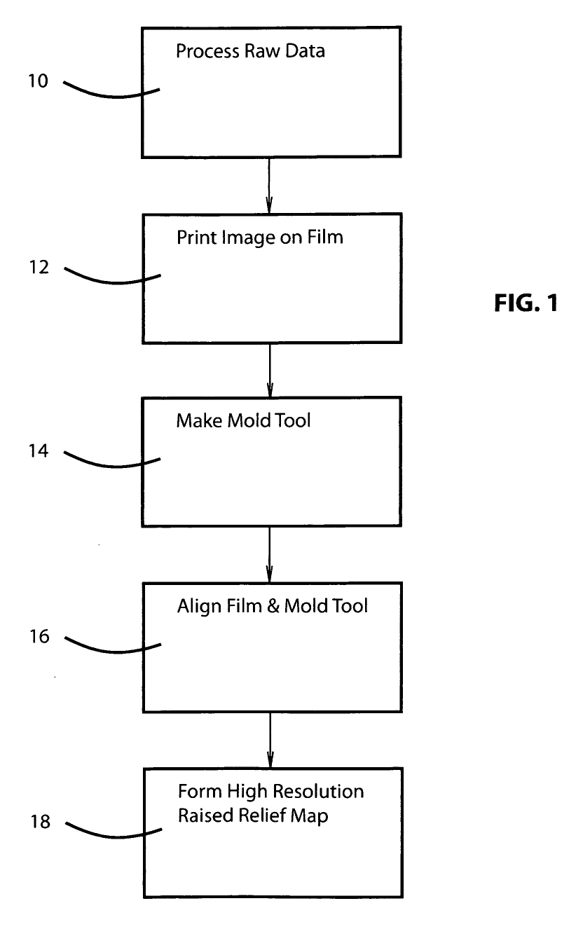

There is shown in FIG. 1 a block diagram of a method of making a very high resolution relief map. The method includes the processing of raw terrain elevation data which includes manipulation of the data to account for slope and other non-flat characteristics of the final map, as indicated at 10. The processed image is then printed on film as indicated at 12. The terrain elevation data is then used to make a thermoforming mold tool as indicated at 14. The printed film and mold tool are then aligned in a thermoforming machine as indicated at 16 and the high resolution relief map is formed as indicated at 18. This method will now be described in detail below.

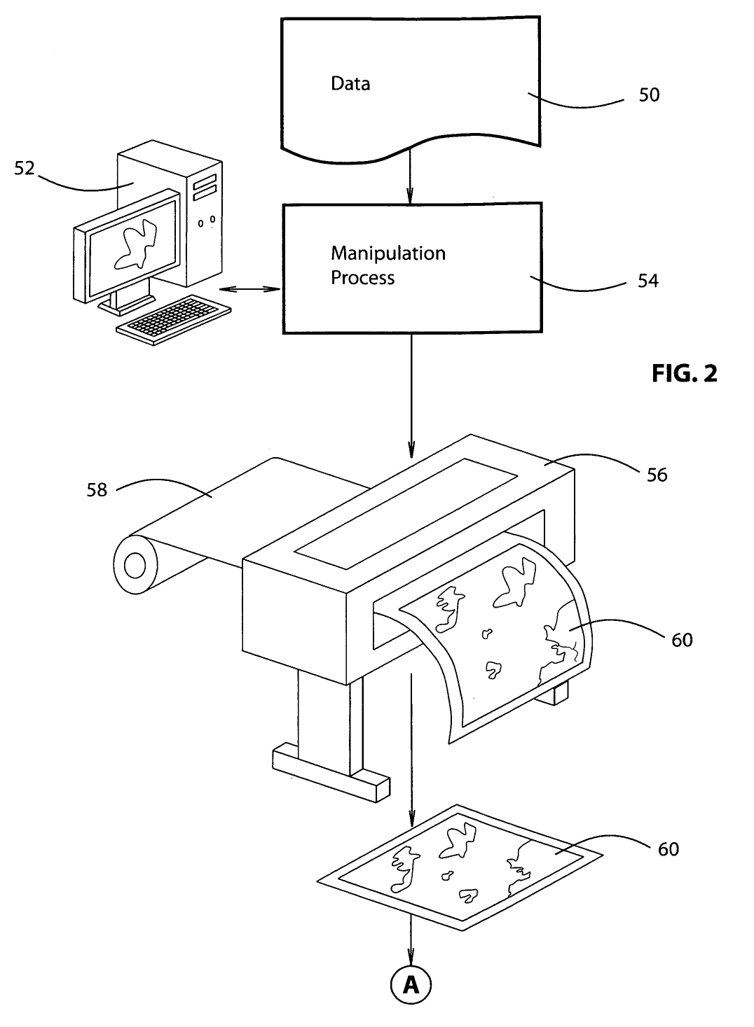

As shown in FIG. 2, raw topographical and image data 50 is input into the system either manually or electronically, and may be manipulated by a computer 52 to account for different geographical systems/projections and variations in slope of the contoured three dimensional map surface. This image data manipulation process 54 is an alternative embodiment of the present invention and will be described in detail below. The image data is then input into a standard film printer 56 along with a sheet of thin formable plastic film 58 and the desired image is printed onto the film producing an image film 60.

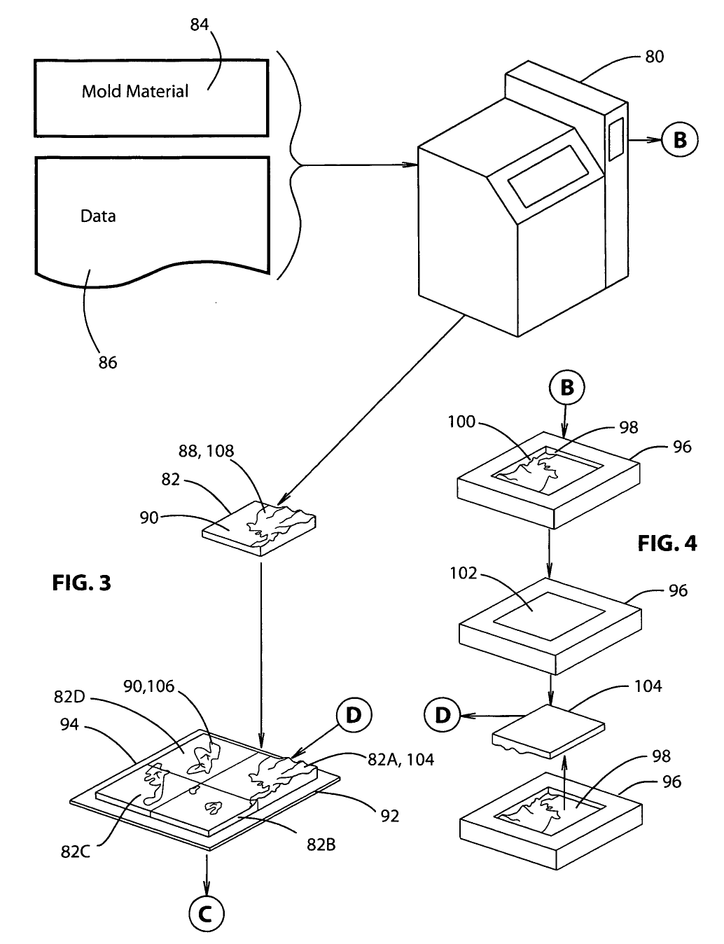

As best seen in FIG. 3, a machine 80, of the rapid-prototyping process kind that is used to make high quantity parts for various modeling applications, is utilized to make a mold form 82. The raw material 84 for the mold form is input into the three dimensional printer by means of a hopper, conveyer, or other means that is well know in the industry. A data set 86 of geographic position and elevation groups is input to the three dimensional printer, either manually or electronically, and is used to manipulate the three dimensional printer 80 to produce topographical shape features 88 on a major surface of the mold form 82 yielding a high resolution three dimensional map surface 90. The mold form 82 is then attached to a tooling plate 92 resulting in a durable and stable mold tool 94. This attachment may be effected by means of a suitable adhesive such as epoxy that is well known in the art or by any other suitable means. Prior art attempts to make a high resolution mold form are normally made by profile machining utilizing expensive machines and time consuming processes such as hand shaping to produce topographical shape features that are of relatively low quality when compared to the high resolution obtained by means of the present invention. This is the first time that a three dimensional printer, that is frequently used to make low quantities of the end product map or other models, is utilized to make a high resolution mold form that is then utilized to make large quantities of the end product map. This allows significantly improved raised relief map resolution at a much lower cost than traditional manufacturing methods. Two or more mold forms 82A, 82B, 82C, and 82D, as shown in FIG. 3, each representing adjacent but different portions of a desired map area may be produced by the machine 80 and attached to appropriate respective positions on the tooling plate 92 to form a mold tool 94. This results in the ability to make a much larger mold tool 94 than would be possible due to physical constraints of the machine 80.

An alternative embodiment of the present invention is shown in FIG. 4 wherein the three dimensional printer 80, instead of making the mold form 82 directly, makes an inverse mold form 96 having a cavity 98 with appropriate topographical map features 100 that are opposite to appropriately corresponding topographical map features 88. A slurry of suitable casting material 102 is poured or injected into the cavity 98 until suitably filled, as shown in FIG. 4. An example of such a slurry of casting material is sold by Adteck Plastic Systems under the trade name Case Polymers. After curing, the solidified material is then removed from the cavity 98 and becomes a mold form 104 having a high resolution map surface 106 and showing topographical map features 108 that are similar to those of the mold form 82. This mold form 104 is then attached to its own tooling plate 92 in a manner similar to that of the mold form 82.

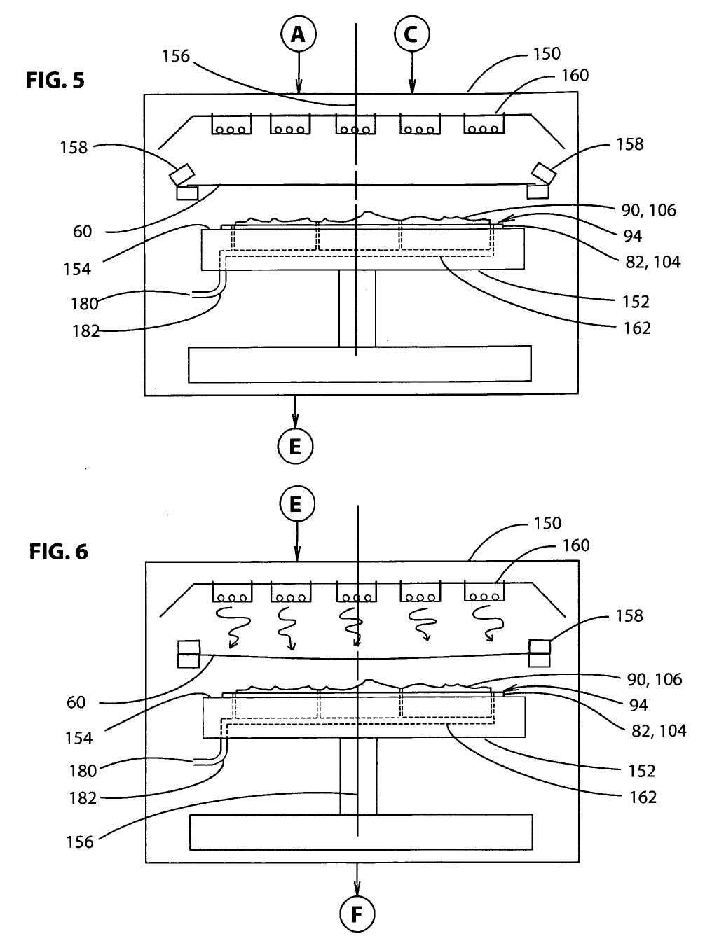

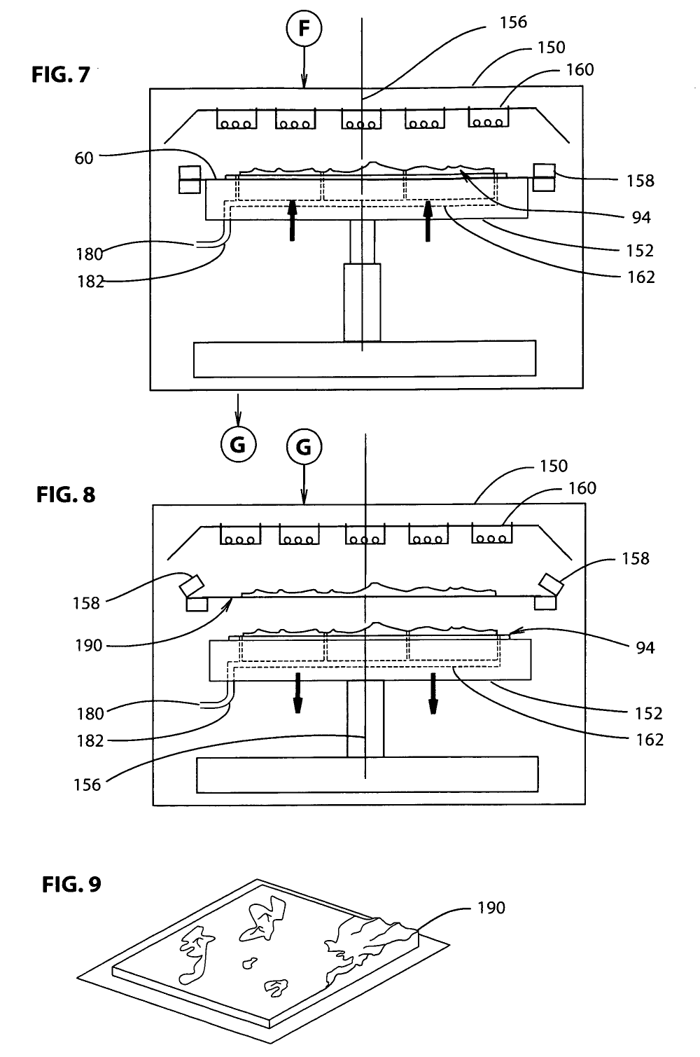

There is shown in FIG. 5 a thin film thermoforming machine 150 including a platen 152 having a tooling mounting surface 154 to which the mold tool 94 is removably secured by any suitable means. The platen 152 is arranged to undergo limited movement along an axis 156 from an open position, shown in FIG. 5 to a closed position shown in FIG. 7. A thin film frame 158 is arranged vertically above the platen 152, as viewed in FIG. 5, and substantially centered on the axis 156. The image film 60 is removably but securely held along its edges in the thin film frame 158 in close proximity to the tool mounting surface 154, leaving suitable clearance between the film and the map surface 90, 106 of the mold tool 94. A heating element array 160 is arranged vertically above the thin film frame 158 so that substantially the entire surface of the image film 60 is exposed to the heating effects of the heating element array. The thin film thermoforming machine 150 includes a vacuum source 180 that is utilized to remove ambient air that is between the surface of the image film 60 and the high resolution map surface 90, 106 during the thermoforming process, as will be explained below. The mold tool 94 includes vent holes 162 such as suitable passages and openings in the mold form 82, 104 and the tooling plate 92 that are in communication with the vacuum source 180 through the conduit 182 for this purpose.

The thermoforming process of the present invention will now be described with reference to FIGS. 5 through 9. A best seen in FIG. 5, the mold tool 94 including the attached mold form 82, 104 is secured to the platen 152, as set forth above. The image film 60 is secured within the thin film frame 158 in close proximity to the high resolution map surface 90, 106 of the mold form 82, 104. As best seen in FIG. 6, the heating element array 160 is energized, by electrical current or other suitable means, to direct radiant heat toward the image film 60 causing it to become somewhat pliable and formable causing it to sag toward the surface 90, 106 of the mold form 82, 104. The platen 152 is then caused to move toward the sagging image film 60 until the mold surface 90, 106, shown in FIG. 7, contacts the image film. Immediately after this movement of the platen 152 the vacuum source is activated to evacuate the ambient air from between the image film 60 and the high resolution map surface 90, 106 to facilitate an intimate contact of the image film 60 with the detail topographical map features 88 of the mold form 82. This causes the image film 60 to conform to the mold form 82 thereby forming a high resolution thermoformed map 190. This intimate contact is important to transfer the high resolution features of the mold form to the image film. The heating element array 160 is then de-energized or removed from the proximity of the map 190 allowing the map 190 to immediately cool and the platen 152 is then lowered and separated from the thermoformed map 190, as shown in FIG. 8. Concurrently with this movement of the platen compressed air is introduced through the conduit 182 and into passageways and openings in the mold tool 94 to facilitate parting of the mold tool and the high resolution thermoformed map 190. The map 190 is then released from the thin film frame 158 and removed from the thin film thermoforming machine 150 and set aside, as shown in FIG. 9. This process is then repeated any desired number of times.

The three dimensional printer 80 disclosed herein is a Model 510 or 650, manufactured by the Z Corporation of Burlington, Mass. Other rapid-prototyping process devices that may be advantageously used in the practice of the present invention are fused deposition modeling and stereolithography.

The image data manipulation process 54, mentioned above and shown in FIG. 2, will now be described in detail. This process is considered another important embodiment of the present invention and entails taking into account the stretching of the printed film 60 as it conforms to the terrain mold. If the shape of the terrain surface is sufficiently varied it can result in the stretched printed image not registering with the terrain shape. Such mismatch can result in significant inaccuracies in the raise relief map and limit its value in many applications. The data manipulation process takes the 2D image or geographic data and predistorts it so that when it is stretched in the forming process, the image on the finished raised relief map properly registers with the terrain shape. This manipulation process can be manually done by digitally stretching the image, or automatic algorithms can be used to estimate the forming distortion and preadistort the image to account for it.

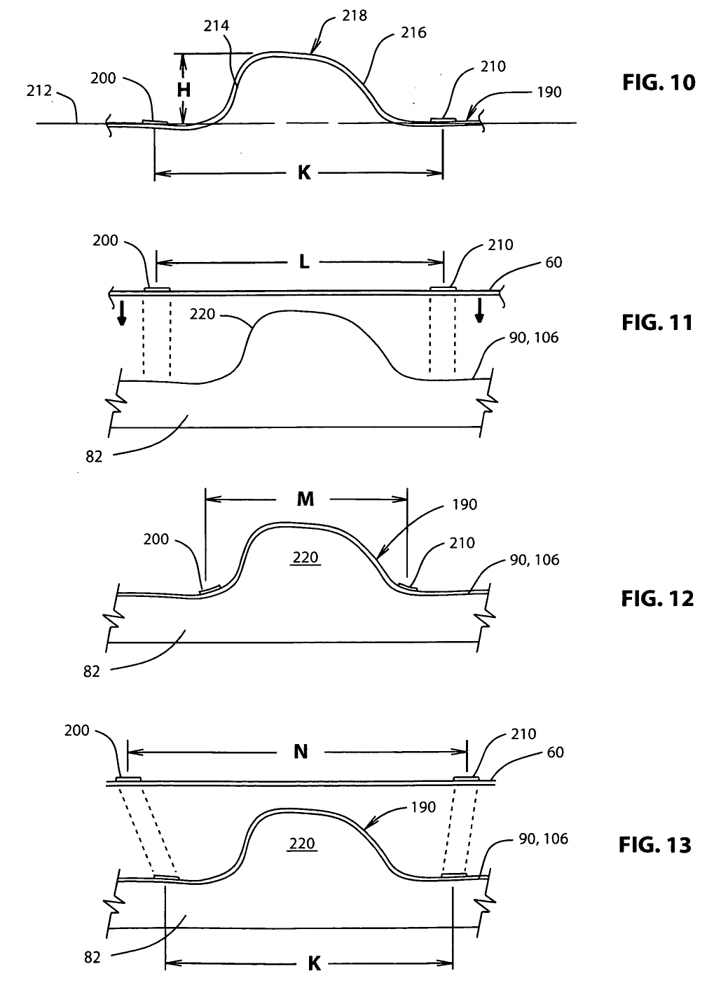

An example of a simplified data manipulation process, incorporating the teachings of the present invention, will now be described with reference to FIGS. 10 through 13. FIG. 10 illustrates the profile view of a desired raised relief map with the printed map elements 200 and 210 correctly registered to the terrain shape, and the correct distance of “K” between the elements. Note, for this illustration, the terrain shape is simply a local area of the thermoformed map 190 that projects upwardly, as viewed in FIG. 10, out of the general plane 212 of the map 190, and represents a typical map feature 218 having a height H and a curved side surface 214 on one side and a curved side surface 216 on the opposite side. The curved side surfaces each have a slope that may be linear or curved and, when curved, the slope may be non-linear having a given rate of change that accurately depicts the slope of the actual terrain being represented. The height and curved side surfaces define unique physical characteristics for each of the topographical map features 220 shown in FIG. 11.

If the map image is simply printed on the film 60 without preprocessing to account for the stretching as the print conforms to the topographical map feature 220 of the terrain mold surface (90, 106) corresponding to the map feature 218, then printed images of the elements as shown in FIG. 11, would have a distance of L equal to K. The dashed lines on FIG. 11 illustrate where one would expect the elements to transfer on the molded surface. As shown in FIG. 12, if printed as shown in FIG. 11, during the thermoforming process the film 60 is stretched over the topographical map feature 220 of the surface 90, 106. When this forming takes place the distance between elements 200 and 210 distorts to length of M, which is shorter than the desired length K. This occurs because the film 60 is required to follow the curved surfaces 214 and 216 during thermoforming. This distortion results in a degradation of the functionality and usefulness of the raised relief map. FIG. 13 illustrates the preprocessing necessary to predistort the print image so that the distance between elements 200 and 210 is N, which is greater than L and K. With this preprocessed image, when the printed film is molded to surface 90, 106 with mold form 82, the final distance between elements 200 and 210 is the correct length K, as shown in FIG. 10. The preprocessing either prestretches or compresses the image elements to account for the film stretching over the terrain surface 90, 106. The preprocessing of the image data elements can be done either manually, by observing the image distortion of a trial molded map and manually adjusting the image data elements to account for the distortion, or by using an automatic algorithm that processes the entire array of image x-y elements by factoring the local terrain elevation, slope, and rates of change in close proximity to each corresponding topographical map feature 220 of the mold. The preprocessing takes into account the lateral positioning of the map elements 200 and 210. This lateral positioning of each map element is affected by the slope of the side surfaces of the portion 220 that are immediately local to each corresponding topographical map element on the mold form 82. This preprocessing of the printed elements to account for the film stretching during thermoforming results in a higher accuracy and more functional raised relief map.

It will be understood that the term “Stereolithography”, as used herein, refers to an additive fabrication process utilizing a vat of liquid UV-curable photopolymer resin and a UV laser to build parts a layer at a time. On each layer, the laser beam traces a part cross-section pattern on the surface of the liquid resin. Exposure to the UV laser light cures, or, solidifies the pattern traced on the resin and adheres it to the layer below. After a pattern has been traced, the SLA's elevator platform descends by a single layer thickness, typically 0.05 mm to 0.15 mm (0.002″ to 0.006″). Then, a resin-filled blade sweeps across the part cross section, re-coating it with fresh material. On this new liquid surface the subsequent layer pattern is traced, adhering to the previous layer. A complete 3-D part is formed by this process. After building, parts are cleaned of excess resin by immersion in a chemical bath and then cured in a UV oven. It will be further understood that the term “fused deposition modeling (FDM) process”, as used herein, refers to a process that is similar to most other RP processes (such as 3D Printing and stereolithography) in that it works on an “additive” principle by laying down material in layers. A plastic filament or metal wire is unwound from a coil and supplies material to an extrusion nozzle which can turn on and off the flow. The nozzle is heated to melt the material and can be moved in both horizontal and vertical directions by a numerically controlled mechanism, directly controlled by a Computer Aided Design software package. In a similar manner to stereolithography, the model is built up from layers as the material hardens immediately after extrusion from the nozzle.

An important advantage of the present invention is that a high resolution mold tool can be easily and inexpensively made utilizing a rapid prototype machine rather than the prior art method of profile milling and related hand forming. Another important advantage of the present invention is that the mold form may be made from a cast material that is more durable than would otherwise be achievable if made directly from the three dimensional printer. That is, the mold form can be cast in tooling epoxy or some other durable material without the need for expensive machining operations. Another important advantage of the present invention is that the accuracy and registration of the finished map image and geographic data are substantially improved by adjusting the positions of the data elements with respect to the slope and depth of each map feature prior to the two dimensional printing on the image film so that after thermoforming the printed feature closely corresponds to its formed feature on the finished map.

1. A method of making a high resolution relief map comprising the steps:
(a) Providing means to effect a rapid-prototyping process for making a thermoforming mold having a high resolution three-dimensional surface which models the three-dimensional surface of the earth with high resolution;
(b) Making said mold having said high resolution three-dimensional surface, said surface having topographical shape features utilizing said means of step (a);
(c) Printing desired map features on a thin formable plastic film using a conventional printing process;
(d) Positioning said printed film in a thermoforming machine such that it is in close proximity to and each of said desired map features is precisely registered to a corresponding said topographical shape feature on said high resolution three-dimensional surface;
(e) Heating said film to a proper molding temperature;
(f) Partially evacuating the space between the film and terrain mold so that atmospheric pressure forces said film into contact with said high resolution terrain three-dimensional surface; then
(g) Cooling said film.

2. The method according to claim 1, wherein said means of step (a) is a three-dimensional printer.

3. The method according to claim 1 wherein said means of step (a) is a stereolithography machine process.

4. The method according to claim 1, wherein said means of step (a) is a fused deposition modeling machine process.

5. The method according to claim 1, wherein said making said mold of step (b) includes attaching a support plate thereto.

6. The method according to claim 1, wherein said making said mold in step (b) includes the step (b1) of forming a tool and then step (b2) of forming said mold from said tool.

7. The method according to claim 1, wherein said printing of step (c) includes printing by means of a high-resolution wide-format inkjet printer.

8. The method according to claim 1 wherein said mold has vent holes around the perimeter of said high resolution three-dimensional surface.

9. The method according to claim 2 wherein said mold has vent holes around the perimeter of said high resolution three-dimensional surface.

10. The method according to claim 1 wherein said making said mold of step (b) includes the step of forming vent holes at key positions in said high resolution three-dimensional surface.

11. The method according to claim 2, wherein said making said mold of step (b) includes the step of forming vent holes at key positions in said high resolution three-dimensional surface.

12. The method according to claim 1, wherein said printing desired map features of step (c) includes step (c1) of providing a set of high resolution image data elements and step (c2) of preprocessing said data elements to improve said registration of step (d) to non-flat portions of said high resolution three-dimensional surface.

13. The method according to claim 12 wherein said preprocessing said set of high resolution data elements of step (c2) includes repositioning a data element in relation to the local slope and rate of change of the corresponding topographical map feature on the mold form.

14. The method according to claim 1 wherein said making said mold of Step (b) includes making at least two said molds and attaching said at least two molds to a single support plate immediately adjacent each other thereby forming a single mold for making a single high resolution relief map.

15. A method of making a high resolution relief map comprising the steps:
(a) Providing a rapid-prototyping process machine for making a thermoforming mold having a high resolution three-dimensional surface which models the three-dimensional surface of the earth with high resolution topographical map features, each said map feature having unique physical characteristics;
(b) Making said mold utilizing said machine of step (a);
(c) Providing a set of high resolution image data elements representing desired map features corresponding to respective topographical map feature on said mold;
(d) Adjusting the position of each of said image data elements in relation to said physical characteristics of its respective corresponding topographical map feature on the mold;
(e) Printing said desired map features, as adjusted in step (d), on a thin formable plastic film;
(f) Positioning said printed film in a thermoforming machine; and
(g) Thermoforming said high resolution relief map.
